(19) United States
(12) Patent Application Publication
(10) Pub. No.: US 2018/0211224 A1
(43) Pub. Date: Jul. 26, 2018

(54) PRODUCT DESIGN CONFIGURATOR INTERFACE

(71) Applicant: Benjamin James Joseph Soppitt, Mill Valley, CA (US)

(72) Inventor: Benjamin James Joseph Soppitt, Mill Valley, CA (US)

(21) Appl. No.: 15/413,157

(22) Filed: Jan. 23, 2017

(51) Int. Cl. G06Q 10/10; G06Q 10/06

(52) U.S. Cl. CPC G06Q 10/103; G06F 3/04847; G06Q 10/06313

(57) ABSTRACT

The invention is directed to a configurator portal that may provide an interactive user interface for use by a configuring entity. The configuring entity can input information into the interactive user interface in order to configure a set of design components (e.g., functionalities, offers, benefits, form factor, etc.) associated with a product, perform analysis for certain combinations of features that can be provided to specific segments of users, and initiate production of the product.

### CROSS-REFERENCES TO RELATED APPLICATIONS

None.

### BACKGROUND

Conventionally, an entity that designs a product lacks the resources to design the product in an optimal manner. For example, the entity may rely on feedback from test subjects to determine the quality of a certain design. Since gathering feedback can be time-consuming, this makes it difficult for the entity to conduct multiple iterations of redesign and testing for the product. Consequently, the entity is not able to gather enough information in order to optimize the design. This situation is especially problematic for situations in which only a short time period is made available for designing the product.

Additionally, this issue is exacerbated when an entity wants to design a product for a specific group of users. For example, the entity typically does not have enough information to efficiently determine with which group of users a design is compatible. Even if they were to conduct testing, it would take a substantial amount of time to locate an appropriate group of users and gather feedback information, as well as compare results to those of a different group of users.

As a result of these and other limitations, products are often moved into production without sufficient analysis of their designs.

Embodiments of the invention address these and other problems, individually and collectively.

### BRIEF SUMMARY

Embodiments of the invention are directed to a product design platform. Embodiments of the invention enable a configuring entity to effectively design a product as well as initiate production of the product using a single platform. For example, the configuring entity can utilize the product design platform to configure features (e.g., functionalities, offers, benefits, form factor, etc.) associated with a product, perform analysis on providing certain combinations of features to specific segments of users, and initiate production of a product.

One embodiment of the invention is directed to a system. The system can comprise a segmentation engine including modules for determining a group of users, a qualification engine including modules for determining whether the group of users is able to receive a set of design components, and a portal in communication with the qualification engine and the segmentation engine, wherein the portal enables a configuring entity to select the set of design components and instruct initiation of production of the product including the set of design components, wherein the product is distributed to the group of users. The set of design component can include one or more of functionalities (e.g., methods of use, etc.), services (e.g., fraud detection services, data analytics services, etc.), form factors, rewards, offers, and benefits.

In some embodiments, the system can also comprise a features repository including offers or benefits associated with the product, wherein the portal is in communication with the features repository. The system may also comprise a fulfillment engine including modules for executing the order for the product including the set of design components, wherein the order initiates the distribution of the product to the group of users, wherein the portal is in communication with the fulfillment engine. The system may further comprise a configuration engine including modules for determining data associated with distributing the product including the set of design components to the group of users and displaying the data in a user interface of the portal. In some embodiments, the data may include an estimated return or a cost.

One embodiment of the invention is directed to a method performed by a computer. The method can comprise receiving a selection indicating a set of design components input by a configuring entity into a user interface, determining a group of users, and initiating production of a product including the set of design components, wherein the product is distributed to the group of users. The set of design component can include one or more of functionalities (e.g., methods of use, etc.), services (e.g., fraud detection services, data analytics services, etc.), form factors, rewards, offers, and benefits.

In some embodiments, the step of determining the group of users can comprise receiving a set of characteristics input by the configuring entity into the user interface and determining, by the computer, the group of users associated with the set of characteristics. The method may also comprise, for each of the design components in the set of design components, determining that the group of users is able to receive the design component.

The method can also comprise determining data associated with distributing the product including the set of design components to the group of users and outputting the determined data to the user interface. In some embodiments, determining data associated with distributing the product including the set of design components can comprise determining data indicating the estimated return associated with distributing the product including the set of design components to the group of users and outputting the data indicating the estimated return to the user interface. In other embodiments, determining data associated with distributing the product including the set of design components can comprise determining data indicating a cost associated with distributing the product including the set of design components to the group of users and outputting the data indicating the cost to the user interface.

In some embodiments, the selection may be a first selection and the set of design components may be a first set of design components. The method may further comprise receiving a second selection indicating a second set of design components input by the configuring entity into the user interface, determining data associated with distributing the product including the second set of design components to the group of users, and updating, by the computer, the user interface to display the data associated with distributing the product including the second set of design components to the group of users.

Embodiments of the invention are also directed to a computer comprising a processor and a computer readable medium coupled to the processor. The computer readable medium may comprise code executable to perform any method described herein.

These and other embodiments of the invention are described in detail below. For example, embodiments are directed to systems and computer readable media associated with methods described herein.

### BRIEF DESCRIPTION OF THE DRAWINGS

FIG. 1 illustrates a block diagram of an exemplary system according to some embodiments of the invention.

FIG. 2 shows an exemplary flow for implementing a configured design according to some embodiments of the invention.

FIG. 3 illustrates an exemplary site map provided by the configurator portal according to some embodiments of the invention.

FIG. 4 shows an exemplary user interface provided by the configurator portal according to some embodiments of the invention.

FIG. 5 shows an exemplary user interface provided by the configurator portal according to some embodiments of the invention.

FIG. 6 shows an exemplary user interface provided by the configurator portal according to some embodiments of the invention.

FIG. 7 shows an exemplary user interface provided by the configurator portal according to some embodiments of the invention.

FIG. 8 shows an exemplary user interface provided by the configurator portal according to some embodiments of the invention.

FIG. 9 shows an exemplary user interface provided by the configurator portal according to some embodiments of the invention.

FIG. 10 shows an exemplary user interface provided by the configurator portal according to some embodiments of the invention.

FIG. 11 shows an exemplary user interface provided by the configurator portal according to some embodiments of the invention.

FIG. 12 shows an exemplary user interface provided by the configurator portal according to some embodiments of the invention.

FIG. 13 shows an exemplary flow for a method of utilizing the configurator portal according to some embodiments of the invention.

### TERMS

Before discussing specific embodiments and examples, some descriptions of terms used herein are provided below.

A “design component” may be a feature associated with a design. In some cases, the design component may be a feature associated with the design of a product. Examples of design components include functionalities (e.g., methods of use) enabled by a design, offers and benefits received with the design, services received with the design (e.g., fraud detection services, data analytics services, etc.), and form factor (e.g., color, material, shape, layout, style, dimensions, etc.).

A “product” may be any item that can be distributed. In some cases, the product may comprise a physical article, such as a device, an automobile, clothing, silverware, furniture, a card, or other item. In other cases, the product may comprise digital data, such as an electronic document or an online package. In some embodiments, the product may include both a physical article and digital data. For example, the product may include a car along with data corresponding to online offers associated with the car.

A “segment” can be a subset of data. The data making up a segment can be associated with one or more common criteria. In some embodiments, a segment of users can comprise data associated with a subset of users that may share common characteristics.

A “configuring entity” may be an entity that designs a product using the product design platform. The configuring entity may be an individual or group of individuals associated with a company, a corporation, a resource providing entity (e.g., merchant), an issuing entity (e.g., issuer), a manufacturer, or other establishment. In some embodiments, the configuring entity may distribute (e.g., sell) the product that they designed utilizing the product design platform. The configuring entity may be capable of interacting with a user interface provided by the product design platform in order to configure features associated with a product, perform analysis for certain combinations of features that can be provided to specific segments of users, and initiate production of a product.

A “processor” may include hardware within a server computer (or other computing device) that carries out instructions embodied as code in a computer-readable medium. An exemplary processor may be a central processing unit (CPU). As used herein, a processor can include a single-core processor, a plurality of single-core processors, a multi-core processor, a plurality of multi-core processors, or any other suitable combination of hardware configured to perform arithmetical, logical, and/or input/output operations of a computing device.

A “computing device” may be any suitable electronic device that can process and communicate information to other electronic devices. The computing device may include a processor and a computer readable medium coupled to the processor, the computer readable medium comprising code, executable by the processor. The computing device may also include input devices and output devices that are operatively coupled to the processor, as well as an external communication interface for communicating with other computing devices or other entities. A mobile device, a cardholder device, a user device, a consumer device, a server computing device, an appliance, and any computer may be exemplary types of computing devices. Some non-limiting examples of a mobile device may include cellular phones, keychain devices, personal digital assistants (PDAs), pagers, notebooks, laptops, notepads, wearable devices (e.g., smart watches, fitness bands, jewelry, etc.), automobiles with remote communication capabilities, personal computers, and the like.

A “server computer” may include any suitable computer that can provide communications to other computers and receive communications from other computers. A server computer may include a computer or cluster of computers. For instance, a server computer can be a mainframe, a minicomputer cluster, or a group of servers functioning as a unit. In one example, a server computer may be a database server coupled to a Web server. A server computer may be coupled to a database and may include any hardware, software, other logic, or combination of the preceding for servicing the requests from one or more client computers. A server computer may comprise one or more computational apparatuses and may use any of a variety of computing structures, arrangements, and compilations for servicing the requests from one or more client computers. Data transfer and other communications between components such as computers may occur via any suitable wired or wireless network, such as the Internet or private networks.

### DETAILED DESCRIPTION

Embodiments of the invention are directed to a product design platform. Embodiments of the invention enable a configuring entity to effectively design a product as well as initiate production of the product using a single platform. In some embodiments, the product design platform can comprise a system that includes a configurator portal engine, a qualification and fulfillment engine, a segmentation engine, and a features repository including offers and benefits information. The configurator portal engine can enable a configurator portal that is in communication with the qualification and fulfillment engine, the segmentation engine, and the features repository. The configurator portal may provide an interactive user interface that the configuring entity can utilize to configure a set of design components (e.g., functionalities, offers, benefits, form factor, etc.) associated with a product, perform analyses for certain combinations of features that can be provided to specific segments of users, and initiate production of a product.

In an exemplary case, a configuring entity may interact with a user interface provided by the configurator portal of the product design platform to configure features of a product, such as a car, meant to be targeted for a segment of users. The configuring entity may utilize the user interface to select the segment of users (e.g., individuals in the region that have bought a similar car in the past) as well as a set of design components associated with the car. In some cases, the set of design components may comprise functionalities to include in the car (e.g., navigation system, self-driving system, etc.), offers and benefits (e.g., discounts for related products, warranty, etc.) that a user can receive with the car, as well as the form factor of the car (e.g., color, size, etc.).

In some cases, the backend processing functions of the product design platform may be performed by a server computer. The server computer can receive data indicating the segment of users and the set of design components selected by the configuring entity and retrieve relevant information associated with the selections. For example, the server computer may determine information related to the segment of users (e.g., number of users, behavioral information, predictive information, etc.) and whether the segment of users qualifies to receive the set of design components.

The configuring entity can utilize the configurator portal to perform analysis of potentially providing the product with various sets of design components to a selected segment of users. In some cases, the server computer may generate values (e.g., expected conversion rate, cost, etc.) and output them to the user interface so that the configuring entity can review the values to determine whether certain design components should be changed according to their objectives. In one exemplary analysis, the configuring entity may find that a car with a smaller size is expected to sell better with the selected segment of users based on comparing the analysis results for two sets of design components indicating different car sizes. Accordingly, the configuring entity may select a smaller car size for the set of design components to be included in the car.

The configuring entity can also utilize the configurator portal to perform analysis of potentially providing the product with a set of design components to various segments of users. In some cases, the server computer may generate values (e.g., expected conversion rate, cost, etc.) and output them to the user interface so that the configuring entity can review the values to determine whether a segment of users to receive a set of design components should be changed according to their objectives. In one exemplary analysis, the configuring entity may find that a car including a self-driving feature is expected to sell better to a first segment of users compared to a second segment of users. Accordingly, the configuring entity may select the set of design components including the self-driving feature to be included in the car targeted for the first segment of users.

When the configuring entity has decided on a set of design components to include in the car, the configuring entity may instruct initiation of production. For example, the configuring entity may utilize the user interface to instruct generation and submission of an order for one or more cars including the selected set of design components. In some embodiments, the submission of the order may cause a manufacturing entity to start producing the car with the selected set of design components.

As illustrated in the exemplary case above, certain embodiments of the invention can provide advantages, some of which are described as follows. One advantage is that embodiments of the invention enable the configuring entity to include a greater variety of design components into a design of a product. This is because the configurator portal can provide the configuring entity access to information pulled from various sources. For example, the configuring entity cannot typically access an offers and benefits attributes database that includes offers provided by entities other than the configuring entity. In order to include such offers, the configuring entity would typically have to separately correspond with the entity providing the offer, which is timely and utilizes computing resources.

Another advantage is that embodiments of the invention enable analysis of a design to be conducted based on up-to-date information. In conventional systems, analyses of designs are often ineffective, since they may be determined based on user feedback information that is outdated. For example, by the time a certain design is implemented in a product, the user feedback based on which the certain design was created may no longer reflect the current user landscape. In contrast, embodiments of the invention can minimize the time taken between analyzing a design and producing the product, such that the analysis based on which the design of the product was created is relevant and thus more likely to produce results according to the configuring entity's objectives.

Another advantage is that the configuring entity can utilize the user interface provided by the configurator portal to easily modify and re-analyze a design, which reduces the time taken for an iteration of a design and test cycle. For example, the configuring entity can review of an analysis of a first design and easily delete, add, or change values of design components to obtain an updated set of design components. The configuring entity is then able to immediately re-analyze a design including the updated set of design components. Unlike conventional user feedback gathering methods in which it is typically not feasible to retrieve user feedback for multiple rounds of re-design, embodiments of the invention enable the process of modifying a design and re-analyzing the modified design to be performed quickly. This allows the configuring entity to perform more iterations of designing and testing, which increases the quality of the resulting design according to the configuring entity's objectives with less time and effort by the configuring entity.

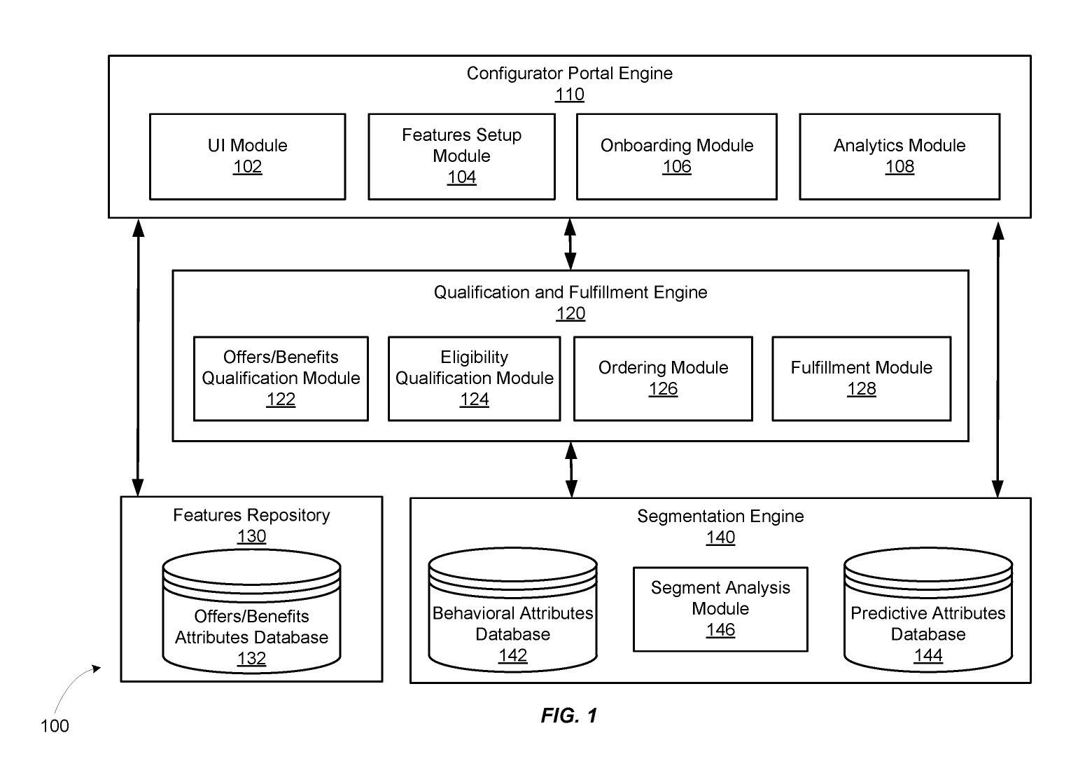

FIG. 1 illustrates a block diagram of an exemplary system 100 according to some embodiments of the invention. The system 100 provides a product design platform and may include a configurator portal engine 110 that is in communication with a qualification and fulfillment engine 120, a features repository 130, and a segmentation engine 140. Each component of system 100 may be implemented by a computing device. Each computing device may comprise a data processor, a system memory, and an external communication interface. The processor, system memory and/or external communication interface may be used in conjunction with any of the modules described below to provide a desired functionality.

In some embodiments, configurator portal engine 110, qualification and fulfillment engine 120, features repository 130, and segmentation engine 140 may be implemented on the same computing device (e.g., server computer). In such cases, functions implemented by code in these engines may be executed by the data processor of the computing device.

In other embodiments, one or more of configurator portal engine 110, qualification and fulfillment engine 120, features repository 130, and segmentation engine 140 may be implemented on separate computing devices (e.g., server computers) that are communicatively coupled to each other over a suitable communications network. In some cases, any of configurator portal engine 110, qualification and fulfillment engine 120, features repository 130, and segmentation engine 140 may be implemented using multiple computing devices. In such cases, functions implemented by code in these engines may be executed by a data processor of the computing device(s) on which they were implemented. Regardless of how the configurator portal engine 110, qualification and fulfillment engine 120, features repository 130, features repository 130, and segmentation engine 140 are physically implemented, communications between these components may enable network-based communications (e.g., Hypertext Transfer Protocol (HTTP), HTTP over Secure Socket Layer (SSL)).

A suitable communications network may enable communication between devices and may be any one or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like.

Each database in system 100 may be a conventional, fault tolerant, relational, scalable, secure database such as those commercially available from Oracle™ or Sybase™. In some embodiments, any of the databases shown may be combined into a single database, or may be separated into multiple databases.

Each engine in system 100 may include one or more modules. In some embodiments, a module may comprise one or more functions implemented by code, executable by a data processor. It is understood that each module shown in system 100 may be combined with modules in system 100 or other additional modules as appropriate. Some examples of additional modules include modules for processing and routing messages, communicating with other devices, data extraction (e.g., for retrieving data from external data sources such as databases) modules, storage modules, encryption modules, and message modification modules. Further, each module may comprise one or submodules, where each submodule may comprise one or more functions implemented by code, executable by a data processor.

Configurator portal engine 110 may comprise a combination of modules that can enable, in conjunction with a data processor, a configurator portal that allows a configuring entity to implement a design for a product. Configurator portal engine 110 may include a UI module 102, a features setup module 104, an onboarding module 106, and an analytics module 108. While not explicitly shown in FIG. 1, configurator portal engine 110 may also include additional modules that are configured to perform other administrative functionality (e.g., service and support, login, general settings, etc.).

UI module 102 may be programmed and/or configured to perform functionality associated with displaying an interactive user interface to a computing device. UI module 102 may enable, in conjunction with a data processor, processing of interactions of a user (e.g., human operator) with the computing device. For example, UI module 102 may determine, in conjunction with the data processor, elements that the user has activated using the user interface and perform, in conjunction with the data processor, actions associated with the activated elements. In some cases, these actions may involve one or more of communicating responses to other modules of configurator portal engine 110 (e.g., features setup module 104, onboarding module 106, analytics module 108), calling functions of other modules of configurator portal engine 110, receiving information from other modules of configurator portal engine 110, updating information or elements displayed by the user interface, and displaying prompts (e.g., notifications, alerts, etc.) to the user.

UI module 102 may be programmed and/or configured to display the user interface in various contexts. In some embodiments, UI module 102 may display, in conjunction with a data processor, a web-based UI in a web browser that is installed on the user's computing device. For example, UI module 102 may generate, with the processor, a webpage displaying user interface elements to the user. In some embodiments, UI module 102 may display, in conjunction with a data processor, the user interface by a client application that is installed on the user's computing device.

Features setup module 104 may be programmed and/or configured to process a user's selection of design components. Features setup module 104 may be able to receive, in conjunction with a data processor, information indicating a set of design components and a segment of users selected by the user from UI module 102. In some embodiments, features setup module 104 may retrieve, in conjunction with the data processor, information (e.g., behavior attributes, predictive attributes, etc.)

associated with the selected segment of users by communicating with segmentation engine 140. In some embodiments, features setup module 104 may retrieve, in conjunction with the data processor, information associated with the selected set of design components from features repository 130. Features setup module 104 can query, with the data processor, qualification and fulfillment engine 120 to determine whether the selected segment of users is qualified to receive the selected set of design components based on the information retrieved from segmentation engine 140 and/or features repository 130. In some cases, features setup module 104 may communicate, with the data processor, the qualification determination to UI module 102, which may cause an alert or notification to be displayed by the user interface.

Onboarding module 106 may be programmed and/or configured to enable offers/benefits receiving entities (e.g., merchants, companies, etc.) to integrate with the product design platform. Onboarding module 106 may enable, in conjunction with the data processor, enrollment processes (e.g., login credential setup, verification processes, etc.) for the offers/benefits receiving entities that establish a relationship between the entity providing the product design platform and the offers/benefits receiving entities. After completion of enrollment processes, onboarding module 106 may enable, in conjunction with a data processor, the offers/benefits receiving entities to receive offers/benefits through their systems. For example, offer notification messages may be received by an application hosted by an offers/benefits receiving entity.

Analytics module 108 may be programmed and/or configured to enable analysis of a set of design components meant to be provided to a segment of users. Analytics module 108 may be able to receive, in conjunction with a data processor, information indicating a set of design components and a segment of users selected by the user from UI module 102. Analytics module 108 may retrieve, in conjunction with the data processor, information (e.g., size of segment, behavior attributes, predictive attributes, etc.) associated with the selected segment of users by communicating with segmentation engine 140. Analytics module 108 may also be able to receive, in conjunction with a data processor, information indicating a type of analysis to be performed based on the set of design components and the segment of users selected by the user from UI module 102.

Analytics module 108 may determine, in conjunction with the data processor, one or more values based on the indicated type of analysis. In some cases, these values output by analytics module 108 may help a configuring entity quantitatively determine whether implementing a certain design meets its objectives. For example, if the configuring entity wants to manage costs spent, it may choose to review an estimated cost of producing the product with the selected set of design components and/or an estimated return on investment value for providing the product with the selected set of design components to the selected segment of users computed by analytics module 108. In another example, if the configuring entity wants to sell the highest number of products possible, it may choose to review an estimated number of products that will be sold computed by analytics module 108. The values output by the analytics module 108 may be determined based on the information retrieved from segmentation engine 140. For example, predictive attributes associated with a selected segment of users may indicate that the segment of users is likely to utilize a certain offer based on their past transactions. This can translate to a high estimated return on investment value for providing this segment of users a product including that offer.

In some embodiments, system 100 may provide a user feedback mechanism that can send evaluation requests regarding certain designs to users, receive evaluation responses, and evaluate evaluation responses (e.g., compute scores). While not required, in some implementations, analytics module 108 may also base its analysis in part on such user feedback information.

Qualification and fulfillment engine 120 may comprise a combination of modules that can enable, in conjunction with a data processor, determination of whether a segment of users qualifies to receive certain features of a design, as well as processing of an order for a product implementing a configured design. Qualification and fulfillment engine 120 may include an offers/benefits qualification module 122, an eligibility qualification module 124, an ordering module 126, and a fulfillment module 128.

Offers/benefits qualification module 122 may be programmed and/or configured to enable determination of whether offers/benefits are valid. Offers/benefits qualification module 122 may be able to receive, in conjunction with a data processor, information associated with offers/benefits selected by the user from configurator portal engine 110. Offers/benefits qualification module 122 may process, with the data processor, the information to determine that the selected offers/benefits are valid. For example, information associated with a selected offer may indicate that it expires next month. Offers/benefits qualification module 122 may determine, with the data processor, that the offer is valid since it is not yet expired. Offers/benefits qualification module 122 may communicate, in conjunction with the data processor, its determination of whether offers/benefits are valid to configurator portal engine 110.

Eligibility qualification module 124 may be programmed and/or configured to enable determination of whether a segment of users qualifies to receive certain offers/benefits. Eligibility qualification module 124 may make the determination, in conjunction with a data processor, based on information associated with an offer/benefit and received from configurator portal engine 110, as well as information associated with a selected segment of users and received from segmentation engine 140. In some embodiments, eligibility qualification module 124 may make the determination, with the data processor, based on qualification information input into the configurator portal by the configuring entity. Eligibility qualification module 124 may communicate, in conjunction with the data processor, its determination of whether a segment of users qualifies to receive certain offers/benefits to configurator portal engine 110.

In an exemplary case, eligibility qualification module 124 may determine, with the data processor, that an offer is meant to be provided to any users with at least a certain amount of spend at a merchant in the past month based on input by the configuring entity. Eligibility qualification module 124 may determine, with the data processor, that the selected segment of users includes users that spent the highest amount at the merchant in the past month. In some embodiments, this information may be indicated in the segment definition or may be retrieved from segmentation engine 140. Eligibility qualification module 124 may determine, with the data processor, that the offer can thus be provided to the selected segment of users since the selected segment of users falls within the group of users to which the offer applies. For example, the segment of users that spent the highest amount at the merchant in the past month may be a subset of users with at least the certain amount of spend at the merchant in the past month.

Ordering module 126 may be programmed and/or configured to enable the configuring entity to order a product that implements the design that they configured using the product design platform. Ordering module 126 may be able to receive, in conjunction with a data processor, information from configurator portal engine 110 that indicates that the configuring entity would like to order a product implementing a design with a set of design components. The information may also indicate other characteristics of the order (e.g., number of products to be ordered, etc.) set by the configuring entity.

In some embodiments, ordering module 126 may include billing submodules that can perform, with the data processor, financial processing associated with the order, such as calculating the total cost of the order based on the configured design and determining the account of the configuring entity to be charged for the order. In some cases, ordering module 126 may communicate, in conjunction with the data processor, billing information to configurator portal engine 110 so that any relevant financial data that may be useful for the user can be displayed by UI module 102. Once the user confirms their order, ordering module 126 may initiate, with the data processor, the process of charging the account of the configuring entity for the order. In some embodiments, this process may comprise routing a transaction message to a transaction entity (e.g., processor computer, authorization computer, etc.), such as by instructing fulfillment module 128 to send the transaction message to the appropriate transaction entity.

It is understood that ordering module 126 can enable, in conjunction with the data processor, the configuring entity to place a single order for products implementing more than one configured design. For example, the ordering module 126 may enable, with the data processor, the configuring entity to place an order for one hundred cars implementing a first set of design components and fifty cars implementing a second set of design components.

Fulfillment module 128 may be programmed and/or configured to enable execution of an order placed by the configuring entity. In some embodiments, execution of an order may involve a physical item to be produced and physically delivered to a user. In other embodiments, execution of an order may involve digital data to be packaged and electronically sent to a user. In yet other embodiments, execution of an order may involve a physical item to be produced and digital data to be packaged, where both are provided to a user. For example, execution of an order may involve a car and electronic offers associated with the car to be provided to a user. Some processes that fulfillment module 128 may handle, in conjunction with a data processor, include offers/benefits fulfillment integration, delivery channel integration, and production fulfillment integration.

Offers/benefits fulfillment integration can involve communicating with offers/benefits providing entities (e.g., third parties, payment processors, resource providers, etc.) to ensure that users can receive offer/benefits. For example, fulfillment module 128 may determine, with the data processor, the method of delivery of offers/benefits (e.g., statement credits, email coupons, etc.) supported by the offers/benefits providing entities and accordingly provide, in conjunction with the data processor, the offers/benefits through appropriate delivery channels. Delivery channel integration can involve establishment of appropriate delivery channels that the product design platform can utilize to deliver alerts, notifications, offers/benefits, and other information.

Production fulfillment integration can involve communicating with the configuring entity or other entity involved in the production of the products ordered to ensure that the product can be produced. For example, fulfillment module 128 may send, in conjunction with the data processor, instructions to initiate production of the ordered products to the configuring entity or other entity involved in the production of the products. The products may be produced upon receipt of these instructions. Fulfillment module 128 may also exchange, in conjunction with the data processor, information with these entities regarding inventory or other data relevant to production.

Features repository 130 may store information related to design components that can be selected by the configuring entity for their designs. In some embodiments, features repository 130 may include an offers/benefits attributes database 132 that can store information related to offers/benefits. In some cases, the information may indicate validity periods, creation dates, offer providing entity identification, conversion statistics, or other data. In some embodiments, features repository 130 may consolidate information from multiple databases that may be managed by various entities. In an exemplary case, features repository 130 may consolidate information from one or more of marketplace offers databases, resource provider offers databases, manufacturer offers databases, authorization entity (e.g., issuer) offers databases, and processor (e.g., payment processor) server databases.

Segmentation engine 140 may be programmed and/or configured to enable analysis of information associated with segments of users. Segmentation engine 140 may comprise a segment analysis module 146, as well as behavioral attributes database 142 and predictive attributes database 144. While not shown in FIG. 1, segmentation engine 140 may be able to access user data (e.g., historical data) that may be stored by the product design platform system, or other entity in communication with the product design platform system.

Segment analysis module 146 may be able to process, in conjunction with a data processor, a request to analyze a segment of users received from configurator portal engine 110 or qualification and fulfillment engine 120. In some embodiments, the request may specify characteristics associated with the segment, where the segment analysis module 146 may then determine, with the data processor, the users that fulfill the specified characteristics. Segment analysis module 146 may collect, in conjunction with the data processor, user data associated with the identified users and perform analysis on the collected user data.

In some cases, segment analysis module 146 may determine, with the data processor, behavioral values based on past behavior of the users and store the determined values in behavioral attributes database 142. For example, segment analysis module 146 may determine, with the data processor, statistics regarding past spend behavior of a segment of users based on their historical transaction data. This information may be stored in behavioral attributes database 142 to provide insight about past behavior associated with a segment of users when analysis is performed by analytics module 108.

In some cases, segment analysis module 146 may determine, with the data processor, predictive values based on past behavior of the users and store the determined values in predictive attributes database 144. In some implementations, segment analysis module 146 may utilize a training model that can analyze patterns in training data and output predictive values. For example, segment analysis module 146 may determine, with the data processor, predicted spend behavior of a segment of users based on patterns detected in their historical transaction data. This information may be stored in predictive attributes database 144 to provide insight about potential future behavior of a segment of users when analysis is performed by analytics module 108.

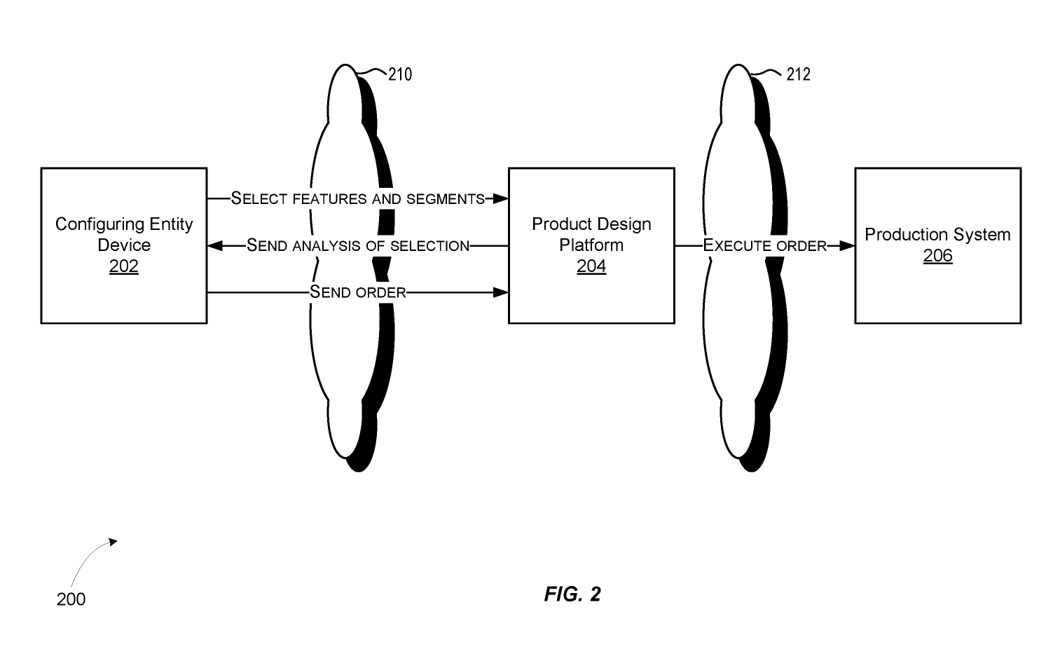

FIG. 2 shows an exemplary flow 200 for implementing a configured design according to some embodiments of the invention. Flow 200 shows a configuring entity device 202 in communication with a product design platform 204 over communications network 210. Flow 200 also shows a production system 206 in communication with the product design platform 204 over communications network 212. Configuring entity device 202 may be any suitable computing device operable by a configuring entity that interacts with a user interface provided by product design platform 204. Product design platform 204 may enable functionalities similar to those described with respect to system 100 of FIG. 1. Production system 206 may be any suitable system (e.g., manufacturer system, resource providing entity system, server computer, etc.) that includes a network interface that enables exchange of electronic information with product design platform 204, and can produce a product for a user.

Configuring entity device 202 may display a user interface associated with a configuration portal provided by product design platform 204 and operable by the configuring entity. Before creating a design, the configuring entity can view various information that may help them with their design. For example, the configuring entity may view descriptions and data related to different segments of users, information related to campaigns, and user experience benchmark results. This information may provide the configuring entity with an idea of the current market and existing types of users.

The configuring entity may interact with the user interface displayed by configuring entity device 202 to select features for a design of a product. In some embodiments, the configuring entity may select a pre-configured set of design components (e.g., baseline features) displayed by the user interface. The configuring entity may simply decide to utilize these pre-configured set of design components for their design, or may modify some of the design components in the pre-configured set of design components. This can save time and effort by the configuring entity. In other embodiments, the configuring entity may select each individual design component for the design using the user interface resulting in a set of design components selected by the configuring entity. The set of design components can include one or more of benefits, offers, functionalities, services, and form factor elements associated with the product.

The configuring entity may also interact with the user interface displayed by configuring entity device 202 to select a segment of users to which the product is to be provided. In some embodiments, the configuring entity may select the segment of users from a list of pre-defined segments of users that has been saved by product design platform 204. Some of these saved segments of users may have been defined by the configuring entity during previous uses of product design platform 204, while some may have been pre-generated by product design platform 204. In other embodiments, the configuring entity may input one or more characteristics of users into the user interface displayed by configuring entity device 202 to indicate the segment of users being selected. In some embodiments, the configuring entity may also input qualification information into the user interface displayed by configuring entity device 202. The qualification information can indicate the criteria that can be utilized to determine whether the selected segment of users can receive the selected set of design components.

In one exemplary case, the configuring entity may select a set of design components and a segment of users for designing a car. The selected set of design components may include a navigation system, a blue exterior color, leather seats, and an offer to be provided through a transportation and parking mobile application. The selected segment of users may be users that are between the ages of 30 to 40 years old.

As shown in flow 200, configuring entity device 202 may send information indicating the features and segment of users selected by the configuring entity to product design platform 204. Product design platform 204 may then analyze the features and segment of users selected by the configuring entity. Product design platform 204 may determine whether the set of design components selected by the configuring entity is valid, as well as whether the selected segment of users is qualified to receive the set of design components. Product design platform 204 may also be able to determine information associated with the selected segment of users, such as its size (e.g., number of users), behavioral attributes indicating analysis of past behavior, and predictive attributes indicating analysis of potential future behavior, and can utilize the determined information to check whether the selected segment of users fulfills qualification criteria input by the configuring entity. For example, if the configuring entity indicates that the selected segment of users (e.g., users that are 30 to 40 years old) should have a spend amount of at least a threshold amount to qualify for the offer included in the set of design components, the product design platform 204 may analyze past spend behavior associated with the segment of users to determine whether they qualify for the offer.

If any of the design components are deemed to be invalid or not able to be provided to the segment of users, product design platform 204 may send an alert or notification to configuring entity device 202. This can indicate to the configuring entity that the selected segment of users or the selected set of design components should be modified. The configuring entity may then select a different segment of users or set of design components and repeat the above steps.

In some embodiments, product design platform 204 may analyze the potential result of providing the product including the selected set of design components to the segment of users. For example, product design platform 204 may generate one or more values (e.g., cost, return on investment value, etc.) computed based on information associated with the segment of users (e.g., size, number of users, etc.), behavioral attributes indicating analysis of past behavior, and predictive attributes indicating analysis of potential future behavior). For example, the product design platform 204 may determine that the selected segment of users (e.g., users that are 30 to 40 years old) are likely to frequently utilize an application to be integrated with the offer. This may be translated to a large return on investment value since the conversion rate of the offer is expected to be high.

As shown in flow 200, product design platform 204 may send information associated with the analysis of the selected features and segment of users to configuring entity device 202. For example, product design platform 204 may send the generated one or more values (e.g., cost, return on investment value, etc.), which can be output on the user interface displayed by configuring entity device 202. In some embodiments, product design platform 204 may generate and send a report including a summary of the selected segment of users, the selected set of design components, and the analysis results that can be viewed by the configuring entity on configuring entity device 202.

In some embodiments, the configuring entity may choose to modify the selected set of design components or segment of users in their design based on the received analysis results. The configuring entity may then interact with the user interface displayed by configuring entity device 202 to select a different combination of design components and different segment of users. The configuring entity may send a request to product design platform 204 to perform another analysis pertaining to the newly selected set of design components and segment of users and receive back the results of the analysis by configuring entity device 202. The updated analysis results can then be output on the user interface displayed by configuring entity device 202. This process of modifying the design and analyzing the modified design can be repeated any suitable number of times until the configuring entity finds a design fulfilling their objectives.

Once the configuring entity has decided on a set of design components to include in their design, the configuring entity can interact with the user interface to place an order. As shown in flow 200, this can cause configuring entity device 202 to send the order to product design platform 204. The order may indicate information indicating the set of design components to be designed into the product, as well as order details (e.g., number of products ordered, order timeline, etc.). The product design platform 204 may receive and initiate processing of the order.

As shown in flow 200, product design platform 204 may execute the received order by communicating with production system 206. In some embodiments, product design platform 204 may provide instructions to production system 206 to fulfill the received order. In some embodiments, product design platform 20 may perform additional actions to fulfill the order. For example, product design platform 20 may perform financial processing associated with the order by communicating with transaction entities to authorize a transaction and charge an account of the configuring entity. Product design platform 204 can also communicate with offers/benefits providing entities to coordinate distribution of any offers/benefits included in the selected set of design components for the order.

In the exemplary case as described above, the selected set of design components may include a navigation system, a blue exterior color, leather seats, and an offer to be provided through a transportation and parking mobile application. Product design platform 204 may send instructions to production system 206 based on order details to produce fifty cars including a navigation system, a blue exterior color, and leather seats, which can cause production system 206 to initiate production according to the instructions. The product design platform 204 may also initiate distribution of the offer included in the selected set of design components. For example, product design platform 204 determine an appropriate delivery channel (e.g., in-app delivery) in which to provide the offer to users. After the production system 206 has produced the cars according to the order, the cars may be shipped to the configuring entity or routed to another entity specified by the configuring entity, and the offers may be distributed.

While an exemplary use case in which the product is a car is described above, embodiments are not so limited. The product may be any physical or digital item that can be designed. In another exemplary case, the product may be a physical or digital card that is to be issued to a user, where the card may be configured to include a set of design components (e.g., form factor, services, channels of use (e.g., contactless, contact, etc.), offers, benefits, etc.).

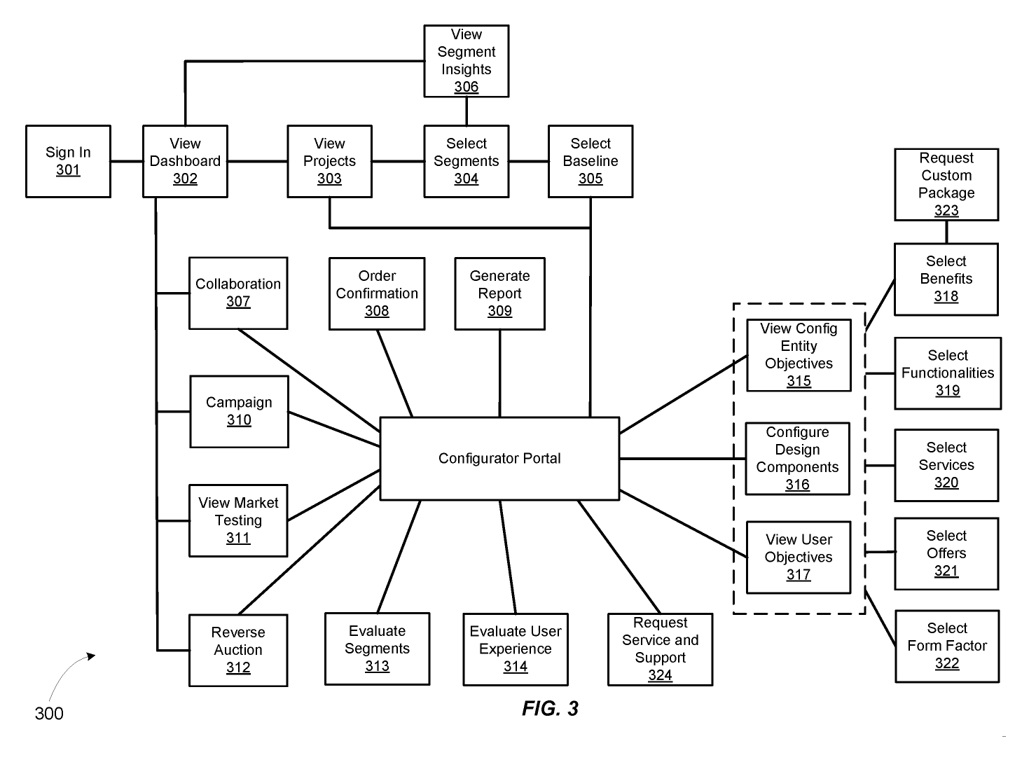

FIG. 3 illustrates an exemplary site map 300 provided by the configurator portal according to some embodiments of the invention. The site map 300 shows various pages through which a configuring entity utilizing the configurator portal of the product design platform can navigate. Any of the pages may provide an interactive user interface that can be displayed on a configuring entity device and into which the configuring entity can input information.

It is understood that the site map 300 shown in FIG. 3 is not meant to be limiting. For example, some pages may not be explicitly shown in site map 300, and in some cases, some pages shown in site map 300 may not be provided by configurator portal. In some cases, any of the pages shown in site map 300 may be made up of multiple pages. Further, any of the pages shown in site map 300 may be combined, mixed, and matched, as one of ordinary skill would recognize. The numbering of the various pages is not meant to be limiting and does not indicate any specific order in which the pages are accessed.

The configurator portal may provide a sign in page 301. In some embodiments, the sign in page 301 may prompt a user to provide sign in credentials (e.g., username and password) before accessing other contents of the configurator portal. After the configuring entity enters their sign in credentials into the sign in page 301, the configurator portal may verify the sign in credentials against information previously stored by the product design platform during an enrollment process with the configuring entity. If the sign in credentials are valid, the configurator portal may allow the configuring entity to access the rest of the configurator portal. In some embodiments, the configurator portal may provide a splash screen before the sign in page 301 is loaded.

The configurator portal may provide a view dashboard page 302. The view dashboard page 302 can provide a summary of activity by the configuration entity's account with the product design platform. In some embodiments, the view dashboard page 302 may display identification information (e.g., project name) of a list of projects that the configuring entity has previously worked on using the configurator portal. In some embodiments, the view dashboard page 302 may also display information related to received announcements, identification of other members with access to the configuring entity account (e.g., name, contact information, etc.), received messages, tools and research, or auction results. The configuring entity can configure the view dashboard page 302 to show any combination of information. The information shown on the view dashboard page 302 may be displayed using user interface elements (e.g., tiles, lists, etc.) that can be activated, which can cause other pages to be opened. For example, identification information of the list of projects may be displayed on a tile, which opens a view projects page 303 when activated.

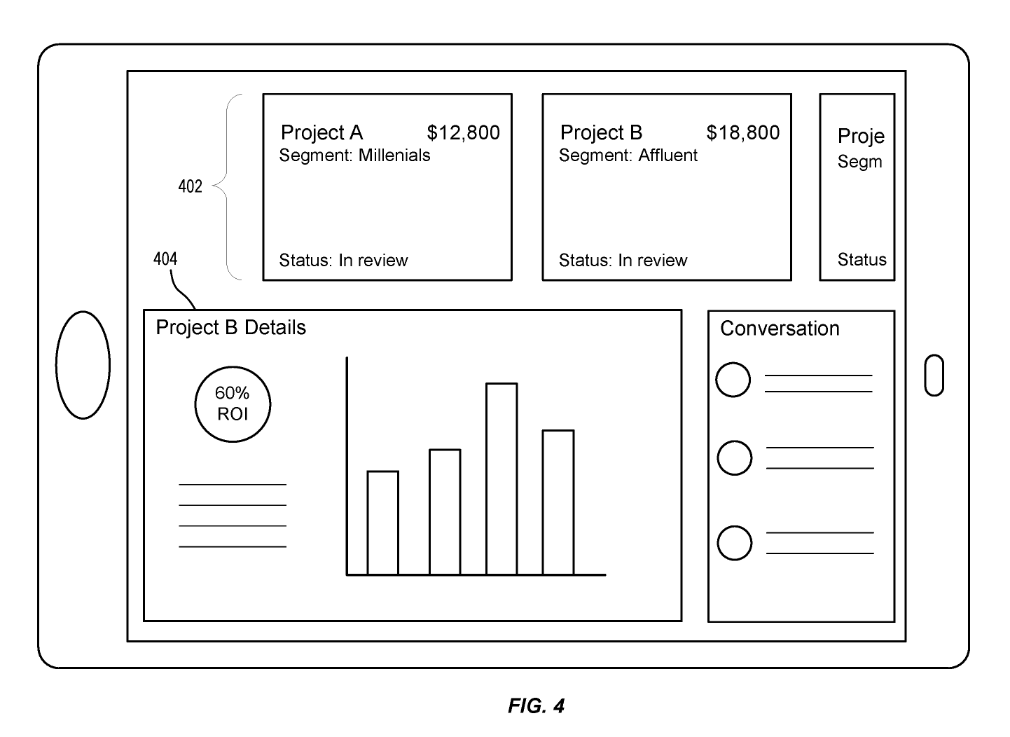

The configurator portal may provide a view projects page 303. Some components of the view projects page 303 may be described with respect to FIG. 4, which shows an exemplary user interface according to some embodiments of the invention. The view projects page 303 may provide a summary of the projects that the configuring entity has previously worked on using the configurator portal. In some embodiments, the information associated with each of the projects displayed may indicate the selected segment of users, the selected type of design (e.g., baseline or custom), the total cost, the status of the project (e.g., pending, in review, etc.). The information associated with each project may be displayed using a user interface element (e.g., tiles, lists, etc.) that can be activated (402 of FIG. 4), which can cause more details about the corresponding project to be displayed. For example, when a tile corresponding to information associated with project B is activated, additional details (e.g., charts and graphs showing analysis of design, comments regarding the project posted by members, etc.) associated with project B may be displayed (404 of FIG. 4). The additional details may be displayed in any suitable manner, such as on another section of the view projects page 303, in a new tab, in a pop-up, etc. As shown in the exemplary user interface of FIG. 4, the configuring entity can work on multiple designs in parallel.

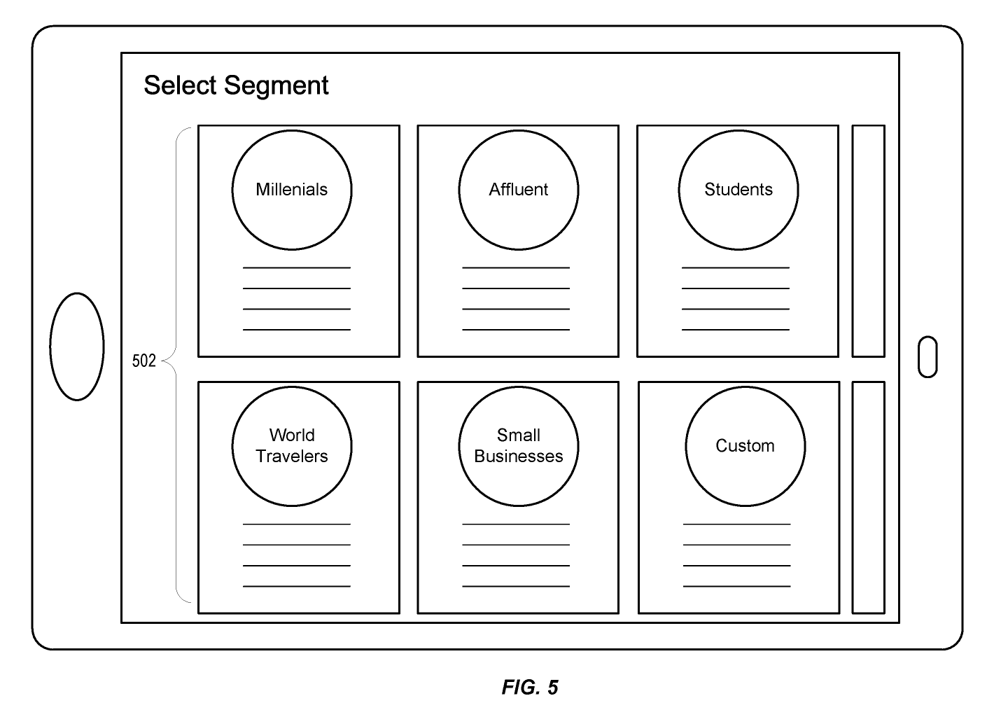

The configurator portal may provide a select segments page 304. Some components of the select segments page 304 may be described with respect to FIG. 5, which shows an exemplary user interface according to some embodiments of the invention. The select segments page 304 may display information indicating a plurality of segments from which the configuring entity may choose for their design. A segment may group users together based on common characteristics (e.g., spend behavior, age, etc.). Some of the segments displayed by the select segments page 304 may be pre-configured by the configurator portal, while some of the segments may be defined and added to the select segments page 304 by the configuring entity. The information associated with each segment may be displayed using a user interface element (e.g., tiles, lists, etc.) that can be activated (502 of FIG. 5), which can cause the corresponding segment to be selected. In some embodiments, further details about each segment may be viewable by the configuring entity before the selection is made. For example, the user interface may be configured such that when a tile corresponding to a segment is double-tapped, a view segment insight page 306 may be displayed. The view segment insight page 306 may display information (e.g., background description, statistics, known tendencies and behavior descriptions, etc.) that may help the configuring entity learn more about a segment.

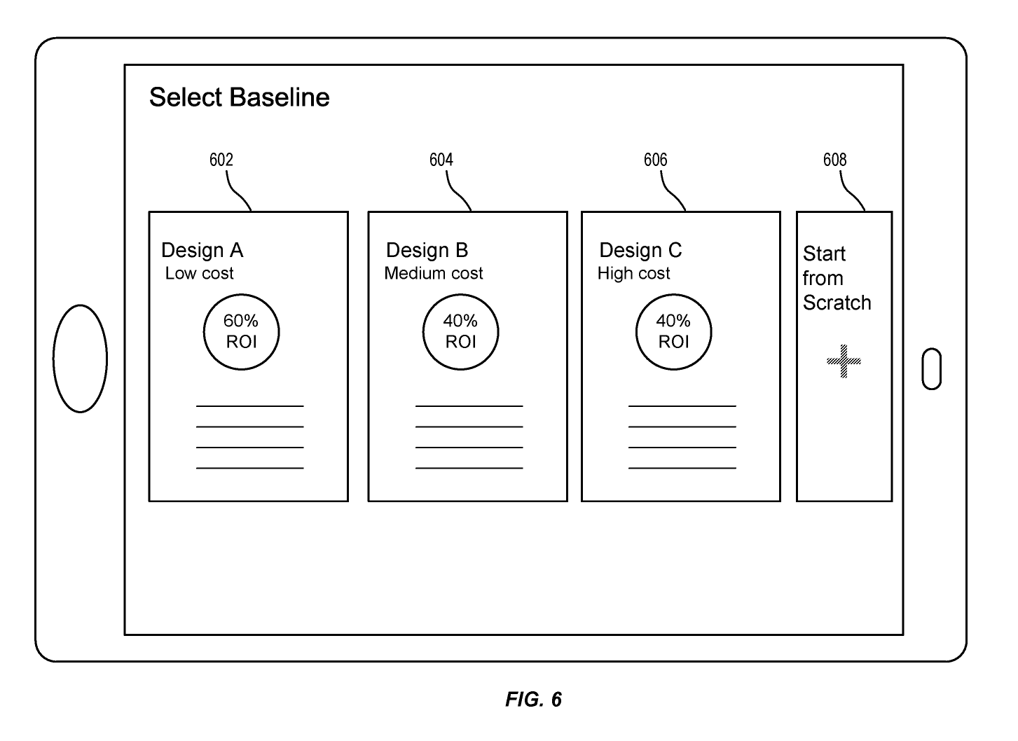

The configurator portal may provide a select baseline page 305. Some components of the select baseline page 305 may be described with respect to FIG. 6, which shows an exemplary user interface according to some embodiments of the invention. The select baseline page 305 may provide the configuring entity pre-configured sets of design components to utilize for their designs (602-606 of FIG. 6). In some embodiments, the configuring entity may select a pre-configured set of design components and utilize it directly for a design. In other embodiments, the configuring entity may select a pre-configured set of design components and then modify it for a design. The use of a baseline set of design components may save the configuring entity some time, as well as forgoes some processing by the configurator portal. The select baseline page 305 may also provide the option for the configuring entity to select a set of design components completely from scratch (608 of FIG. 6).

The configurator portal may provide a collaboration page 307. The collaboration page 307 may display information related to other individuals or entities contributing to the projects being implemented using the configurator portal. In some embodiments, the information may be related to members associated with the configuring entity that are also able to utilize the configurator portal. For example, the information may include contact information of these members or correspondence (e.g., messages) with these members.

The configurator portal may provide a campaign page 310 and a view market testing page 311. The campaign page 310 may provide information related to campaigns (e.g., online advertisement) associated with the product being designed utilizing the configurator portal. In some embodiments, the information may include descriptions of the campaigns and the durations for which they were utilized. The view market testing page 311 may show results of implementing the campaigns, including information related to users that received the campaign and conversion rates. The information provided by the campaign page 310 and the view market testing page 311 may help demonstrate the conditions of the market for the configuring entity.

The configurator portal may provide a reverse auction page 312. The reverse auction page 312 may enable the configuring entity to perform reverse auctions with various resource providing entities. In some embodiments, the reverse auction page 312 may allow the configuring entity to post bids to resource providing entities for opportunities to provide offers/benefits packages to their users.

The configurator portal may provide an evaluate segments page 313. The evaluate segments page 313 may enable the configuring entity to analyze the potential result of providing a set of design components to a segment of users. For example, the evaluate segments page 313 may enable the configuring entity to run benchmark testing that can output values indicating whether a segment of users is expected to react favorably to receiving a product that includes a certain set of design components. Exemplary values output on the evaluate segments page 313 may include a return on investment value and an average profit per product.

The configurator portal may provide an evaluate user experience page 314. The evaluate user experience page 314 can enable the configuring entity to quantitatively determine a user's experience with receiving a product including a set of design components. For example, upon the configurator portal receiving feedback data associated with a particular segment of users and a particular set of design components, the configurator portal can analyze the feedback data to determine a set of values from the set of design components. The values may represent scores indicating whether users had a positive response to certain design components and may be displayed by the evaluate user experience page 314. In some embodiments, an overall value may be generated based on the set of values. The overall value may represent a score indicating whether users had a positive response to the set of design components and may be displayed by the evaluate user experience page 314. In some embodiments, the feedback data may include feedback obtained through interactions with one or more participants from the selected segments of users within a feedback gathering effort.

The configurator portal may provide a view configuring entity objectives page 315 and a view user objectives page 317. The view configuring entity objectives page 315 can include information indicating the objectives of the configuring entity for creating a design using the configurator portal. In some cases, these may objectives may include one or more of profitability, user satisfaction, quality, etc. The view user objectives page 317 may include information indicating the objectives of the users of a product implementing a design. In some embodiments, this information may be determined based on previously collected user feedback or scores calculated based on user feedback. This information may provide a basic landscape of existing users for the configuring entity when configuring a design.

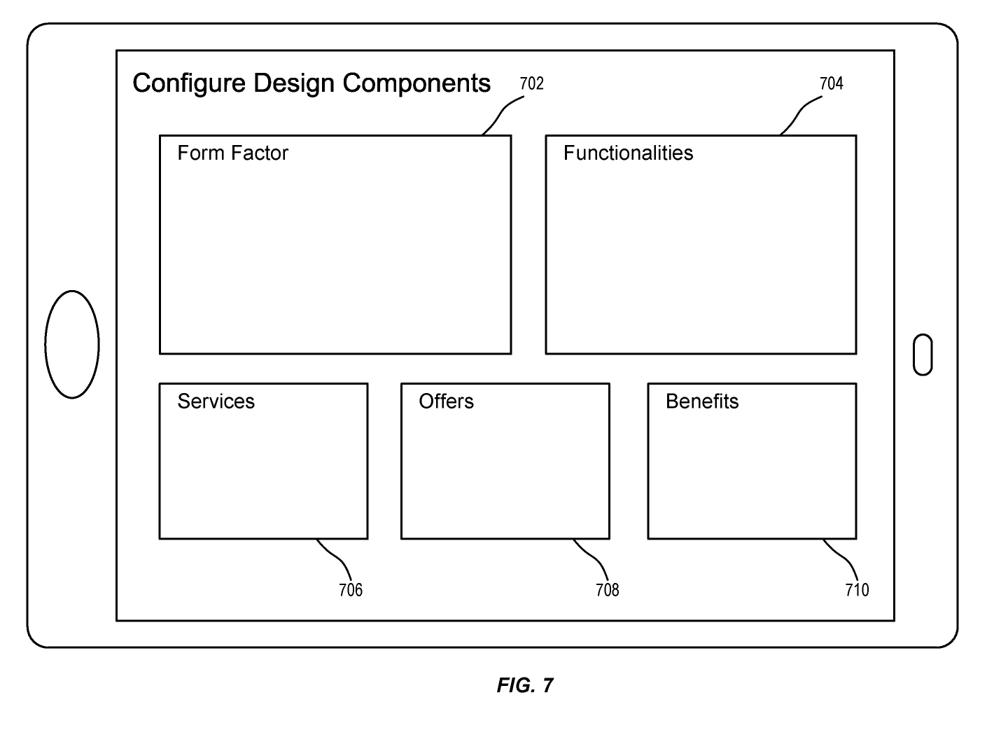

The configurator portal may provide a configure design components page 316. The configure design components page 316 may enable the configuring entity to configure the set of design components to be included in their design. Some components of the configure design components page 316 may be described with respect to FIG. 7, which shows an exemplary user interface according to some embodiments of the invention. In some embodiments, the configurable design components may be associated with categories including offers/benefits, functionalities, services, and form factor. In some embodiments, each category may correspond to a user interface element (e.g., tile, button, etc.) that can be activated (702-710 of FIG. 7), which can cause a page for configuring design components from the corresponding category to be opened. For example, activating tile 702 of FIG. 7 may open a select form factor page 322, activating tile 704 of FIG. 7 may open a select functionalities page 319, activating tile 706 of FIG. 7 may open a select services page 320, activating tile 708 of FIG. 7 may open a select offers page 321, and activating tile 710 of FIG. 7 may open a select benefits page 318.

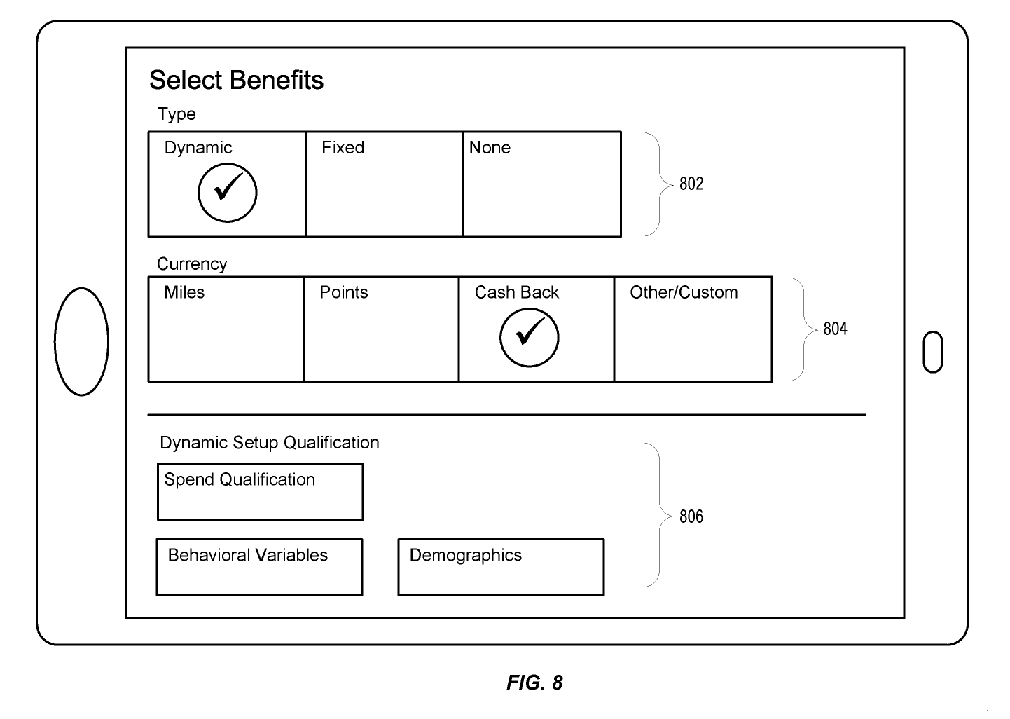

The select benefits page 318 may enable the configuring entity to configure benefits to include in a design. Some components of select benefits page 318 may be described with respect to FIG. 8, which shows an exemplary user interface according to some embodiments of the invention. While not explicitly shown in FIG. 8, select benefits page 318 may enable the configuring entity to select a category from which to provide benefits. Exemplary categories may include business services, delivery and services, family care, food and drink, health and beauty, home services, affluent, media and entertainment, pet care, protections and insurance, reservations and ticket, transportation and parking, travel and lifestyle, and high net worth.

In some embodiments, the select benefits page 318 can allow for the configuring entity to further select a type (802 of FIG. 8), currency (804 of FIG. 8), and additional characteristics associated with benefits. In an exemplary case, the additional characteristics may comprise criteria in which to evaluate dynamic benefits (806 of FIG. 8). The configuring entity may configure which information should be utilized to dynamically determine whether certain users qualify for the dynamic benefits. The information may fall within categories, such as spend qualification information, behavior variables, or demographics. The configuring entity may activate a user interface element (e.g., tile) corresponding to a category to view selectable options (e.g., all spend, channel, merchant category, individual merchant, international, and custom for spend qualification) and specify criteria (e.g., spend amount threshold). For example, the configuring entity may select to evaluate spend qualification for users based on a spend amount threshold in order to determine whether users qualify to receive a benefit. Accordingly, the configurator portal may check that a user is associated with a spend amount greater than the threshold before providing the benefit to the user.

In some embodiments, if the configuring entity wants to configure a custom benefit on select benefits page 318, a request custom package 323 page may be opened. The request custom package 323 page may display a user interface that enables the configuring entity to specify customized properties associated with a benefit to include in a design.

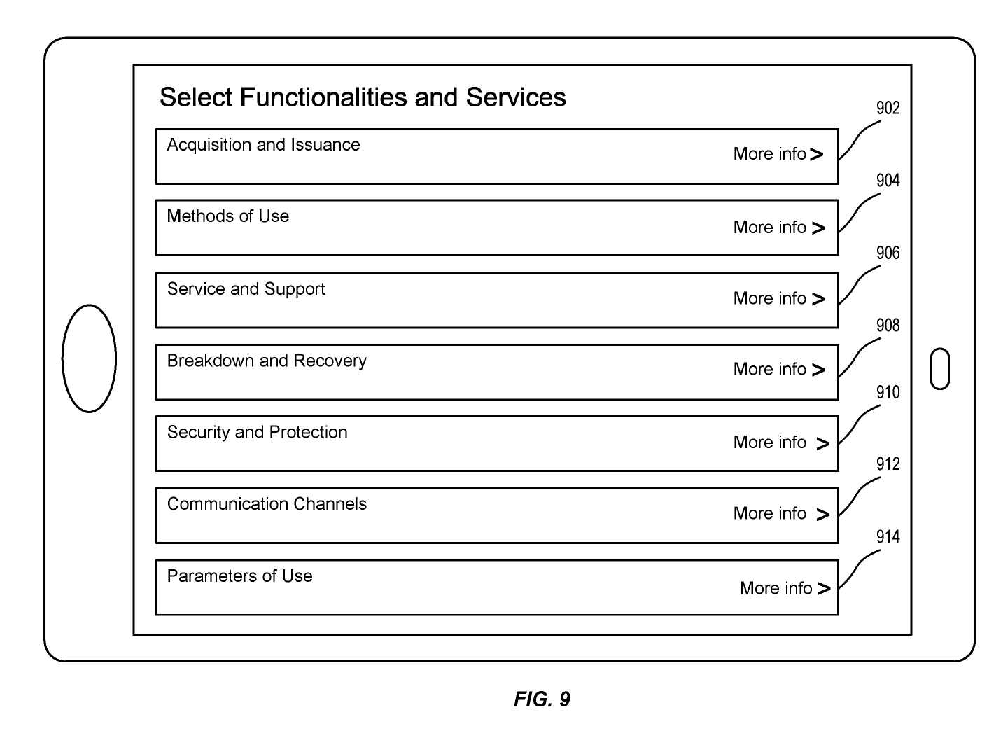

The select functionalities page 319 may enable the configuring entity to configure functionalities to be include a design and the select services page 320 may enable the configuring entity to configure services to be made available when implementing the design. Some components of the select functionalities page 319 and the select services page 320 may be described with respect to FIG. 9, which shows an exemplary user interface according to some embodiments of the invention. While FIG. 9 shows an exemplary case in which the select functionalities page 319 and select services page 320 are combined, embodiments are not so limited. In other embodiments, they may be implemented on separate pages.

The select functionalities page 319 and the select services page 320 may provide various categories of functionalities that the configuring entity can configure. In some embodiments, each category may be displayed using a user interface element (902-914 of FIG. 9) that can be activated to allow the configuring entity to view more detailed options (e.g., in a new window, page, pop-up, etc.) within a category that can be selected for their design.

In an exemplary case, the categories may include acquisition and issuance, methods of use, service and support, breakdown and recovery, security and protection, communication channels, and parameters of use. Upon activating user interface element 902, the configuring entity may be provided with options related to acquisition and issuance. Examples of these options may include setting a method of issuing a product (e.g., direct shipment) or setting a bonus or warranty to be received upon acquisition. Upon activating user interface element 904, the configuring entity may be provided with options related to methods of use. Examples of these options may include setting a time period, location, or channel that the product can be utilized. Upon activating user interface element 906, the configuring entity may be provided with options related to service and support. Examples of these options may include setting certain service and support APIs (e.g., online support service, etc.) to be made available during use of a product. Upon activating user interface element 908, the configuring entity may be provided with options related to breakdown and recovery. Examples of these options may include setting conditions related to replacing a lost or broken product. Upon activating user interface element 910, the configuring entity may be provided with options related to security and protection. Examples of these options may include setting certain security and protection related APIs (e.g., fraud service, analytics service, location detection service, etc.) to be made available during use of a product. Upon activating user interface element 912, the configuring entity may be provided with options related to communication channels. Examples of these options may include setting communication channels that can be utilized to contact a user of a product or provide offers and benefits to a user of a product. Upon activating user interface element 914, the configuring entity may be provided with options related to parameters of use. Examples of these options may include setting an amount (e.g., mileage, spend, etc.) that the product can be utilized over a time period (e.g., daily, weekly, monthly, etc.).

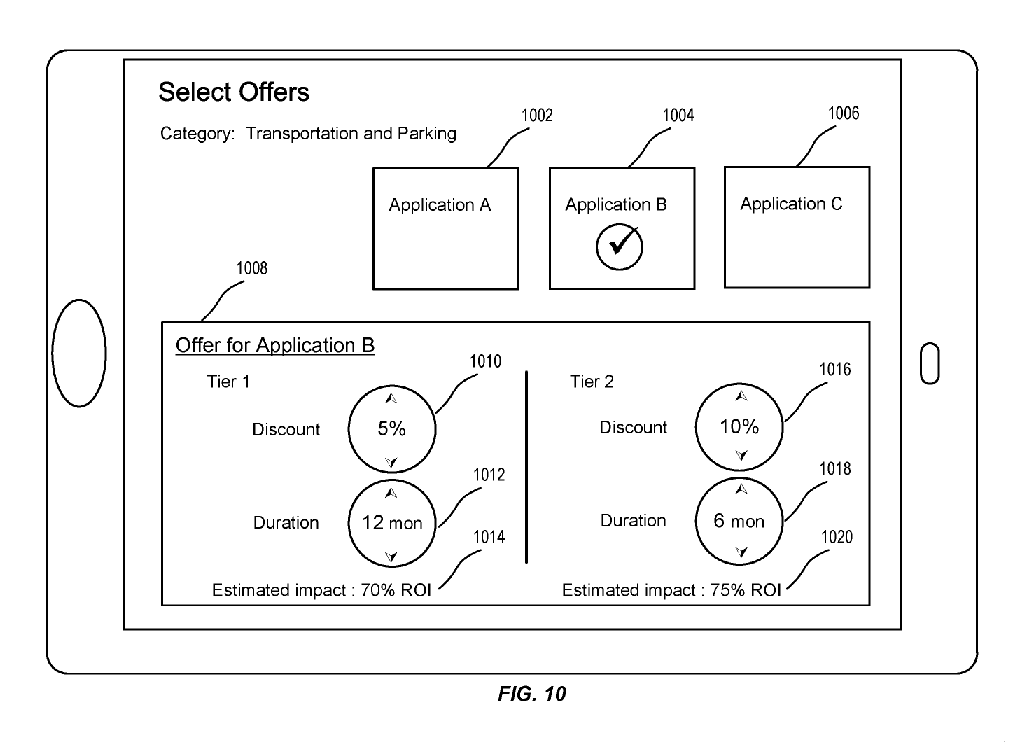

The select offers page 321 may enable the configuring entity to configure offers to include in a design. Some components of select offers page 321 may be described with respect to FIG. 10, which shows an exemplary user interface according to some embodiments of the invention. While not explicitly shown in FIG. 10, the select offers page 321 may enable the configuring entity to select a category from which to provide offers. Exemplary categories may include business services, delivery and services, family care, food and drink, health and beauty, home services, affluent, media and entertainment, pet care, protections and insurance, reservations and ticket, transportation and parking, travel and lifestyle, and high net worth. In some embodiments, the select offers page 321 may be combined with the select benefits page 318. In these cases, the criteria configured to dynamically determine whether certain users qualify for the benefits may also apply to offers.

In some embodiments, the select offers page 321 can allow for the configuring entity to configure an offer to be provided through a specific channel. For example, as shown in FIG. 10, if the configuring entity selects to configure an offer from the transportation and parking category, the configuring entity may be able to configure offers that can be received through one or more mobile applications associated with the transportation and parking category. Each of the mobile applications may be displayed using a user interface element (e.g., 1002 for application A, 1004 for application B, 1006 for application C. The configuring entity may choose to configure offers associated with application B by activating 1004, which can then cause further details to be displayed as shown in offer details 1008. The configuring entity may specify parameters associated with the offers, such as a discount amount and a duration.

In some implementations, the configuring entity may select offers to be provided to multiple tiers, each corresponding to different groups of users within a segment. For example, tier 1 may correspond to frequent users of application B and tier 2 may correspond to less frequent users of application B. The configuring entity may input information into user interface elements 1010 and 1012 to specify a discount amount and duration, respectively, for users associated with tier 1. The estimated impact information 1014 for the specified discount amount and duration can be displayed to help the configuring entity evaluate the offer. For example, the estimated impact information 1014 may show that there is a 70% return on investment expected when providing a discount amount of 5% for a duration of 12 months to tier 1 users of application B. Similarly, the configuring entity may input information into user interface elements 1016 and 1018 to specify a discount amount and duration, respectively, for users associated with tier 2. The estimated impact information 1020 may show that there is a 75% return on investment expected when providing a discount amount of 10% for a duration of 6 months to tier 2 users of application B. The estimated impact information 1014 may be re-calculated and updated when the configuring entity modifies the values of user interface elements 1010 or 1012 and the estimated impact information 1020 may be re-calculated and updated when the configuring entity modifies the values of user interface elements 1016 or 1018.

It is understood that the configurable characteristics (e.g., discount amount and duration) associated with the offer as shown in FIG. 10 are not meant to be limiting. Any other characteristics associated with an offer may be configured by the configuring entity using the select offers page 321. Further, other information may be displayed instead of or in addition a return on investment value for the estimated impact information to help the configuring entity evaluate the offer.

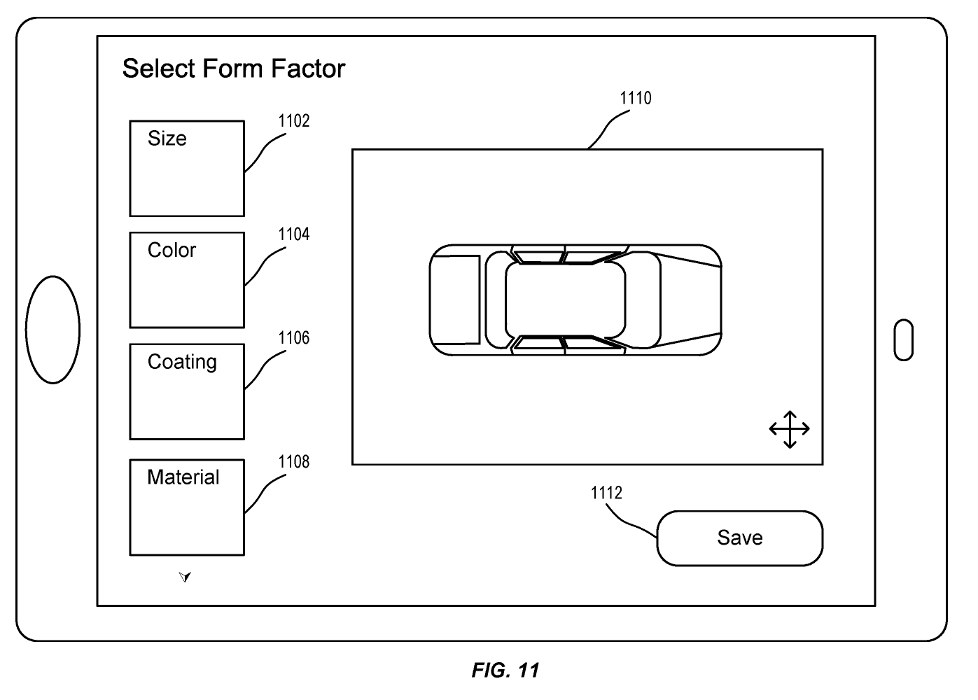

The select form factor page 322 may enable the configuring entity to configure form factor elements to include in a design. Some components of select offers page 321 may be described with respect to FIG. 11, which shows an exemplary user interface according to some embodiments of the invention. The select form factor page 322 may display a number of user interface elements (1102-1108 of FIG. 11) corresponding to form factor elements, where the configuring entity can activate the user interface element to view options associated with each form factor element. For example, the configuring entity can activate user interface element 1102 to view options (e.g., in new window, new page, pop-up, etc.) for configuring the size of a product. The configuring entity can perform similar actions for user interface element 1104 for configuring the color, user interface element 1106 for configuring the coating, and user interface element 1108 for configuring the material of the product. Other form factor elements not shown by FIG. 11 may be included in the select form factor page 322, and not all of the form factor elements shown by FIG. 11 need to be provided.

The select form factor page 322 may also include a preview 1110 that displays an exemplary model of the product including the form factor elements configured by the configuring entity. The preview 1110 may be updated when the configuring entity changes the configuration of form factor elements. For example, the preview 1110 may initially display a product of large size that is painted blue based on the selection made by the configuring entity. When the configuring entity changes their selection to configure a product with a smaller size that is painted red, the preview 1110 may accordingly be updated to display the product with the smaller size and painted red. Any of the models displayed by the preview 1110 may be saved when the configuring entity activates the user interface element 1112, which may be a “Save” button, or the like. The preview 1110 may display the model in any suitable manner, such as by showing multiple two dimensional images or enabling an interactive three dimensional model that can be rotated.

The configurator portal may provide a generate report page 309. The generate report page 309 may enable the configuring entity to generate a report (e.g., pro forma) that aggregates information regarding projects being implemented using the configurator portal. In some embodiments, the generate report page 309 may provide options for a method of delivery (e.g., email attachment, web link, etc.) of a report, a format of the report (e.g., PDF, WORD, TXT, etc.) and write permissions (e.g., editable) that the configuring entity can select. The generate report page 309 may also prompt the user to select the types of information to be included in the report, such as project details, project summary, selected offers/benefits summary, selected functionality summary, and user feedback score. Upon selection of these options, a report may be generated by the configurator portal and sent to the destination (e.g., email address) selected by the configuring entity.

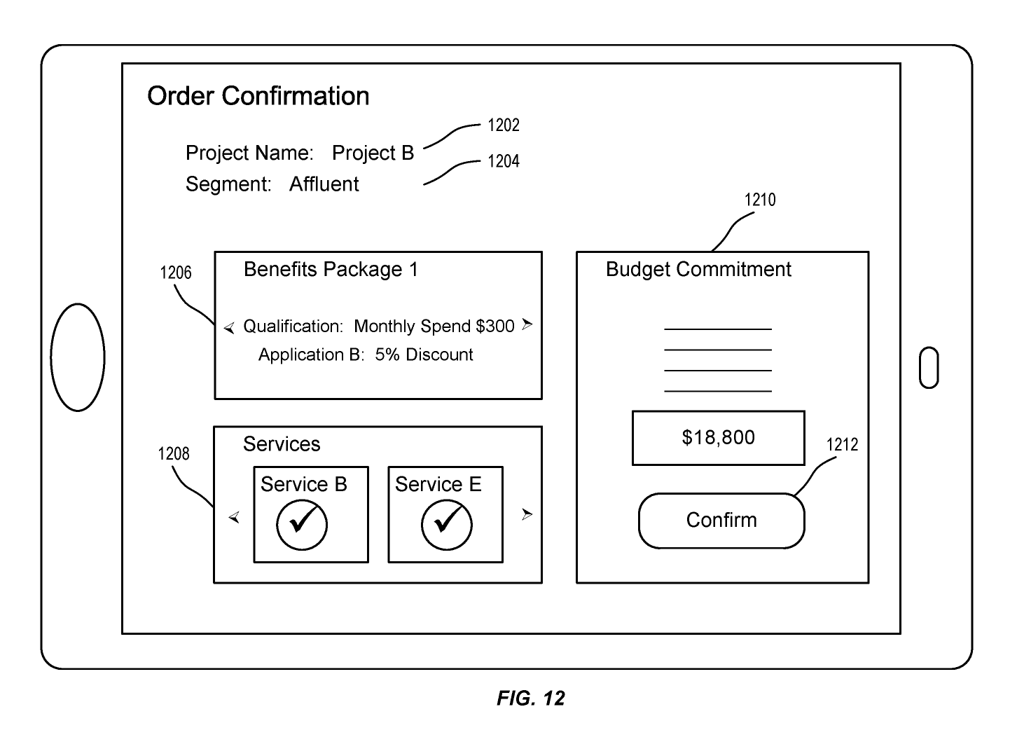

The configurator portal may provide an order confirmation page 308. The order confirmation page 308 may enable the configuring entity to confirm order details, as well as submit an order. The order may be for a certain number of products that the configuring entity designed utilizing the configurator portal. Some components of the order confirmation page 308 may be described with respect to FIG. 12, which shows an exemplary user interface according to some embodiments of the invention. The order confirmation page 308 may display order details, such as a project name associated with product being ordered (1202 of FIG. 12), the segment of users for which the product is designed (1204 of FIG. 12), information related to design components selected by the configuring entity to be designed into the product (e.g., benefits packages (1206 of FIG. 12) and services to be provided with the product (1208 of FIG. 12)), and the cost of the order (1210 of FIG. 12). The configuring entity may confirm the order by activating a user interface element, such as a “Confirm” button (1212 of FIG. 12), which can cause the order to be processed by the product design platform.

The service and support page 324 may enable the configuring entity to access resources for assistance with utilizing the configurator portal. The service and support page 324 may provide information regarding instruction for utilizing the configurator portal and other descriptions of the product design platform. In some embodiments, the service and support page 324 may also enable communication channels for corresponding with a help desk.

It is understood that the user interfaces shown in FIG. 4-12 are not meant to be limiting. Any of the user interface elements shown in these figures may be modified or replaced with other suitable user interface elements as one of ordinary skill in the art would recognize. The user interface elements may be activated using any suitable action, such as a click, press, swipe, slide, double-tap, etc.

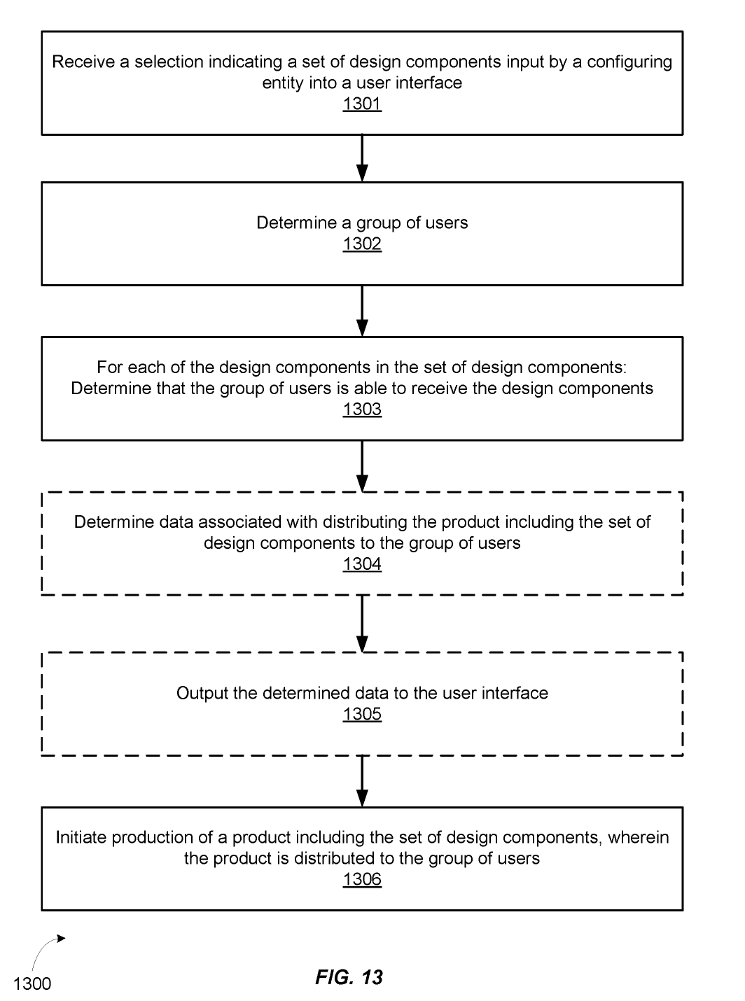

FIG. 13 shows an exemplary flow 1300 for a method of utilizing the configurator portal according to some embodiments of the invention. The method may be performed by a computer. In some embodiments, the computer may be part of a product design platform that enables the configurator portal. The computer may be in communication with a computing device operated by a configuring entity.

At step 1301, the computer may receive a selection indicating a set of design components input by a configuring entity into a user interface. The user interface may be associated with the configurator portal and can be displayed on the computing device operated by the configuring entity. The configuring entity may interact with the user interface, which may include multiple pages or views. For example, the user interface may include any of the exemplary user interfaces shown in FIGS. 7-11. The configuring entity may select the set of design components, which may then be sent to the computer.

The set of design components may include features associated with a product. The product may be a physical product (e.g., a car) or a digital product (e.g., a digital wallet). The set of design components may include one or more of functionalities (e.g., methods of use, etc.), services (e.g., fraud analysis services, data analytics services, etc.), form factors, rewards, offers, and benefits. In some embodiments, a design component may be a visual feature that can be designed into a product. For example, the design component may indicate a material or color to be utilized to create the product. In some embodiments, a design component may indicate a feature regarding the use of a product. For example, the design component may indicate a channel in which the product can be utilized. In some embodiments, a design component may indicate a feature regarding offers or benefits associated with the product. For example, the design component may indicate an online offer to be received upon purchase of the product. Any suitable combination of design components may be selected for a design of a product.

At step 1302, the computer may determine a group of users. The group of users may also be known as a segment of users. In some embodiments, the computer may determine the group of users based on information input by the configuring entity. For example, the computer may receive a set of characteristics input by the configuring entity into the user interface and then determine the group of users associated with the set of characteristics (e.g., by sending a query to a segmentation engine). The set of characteristics can include any attributes that may be associated with users, such as age, region, affiliations (e.g., universities, businesses, etc.), historical behavior (e.g., traveling behavior, spending behavior, etc.), predictive behavior (e.g., predicted traveling behavior, predicted spending behavior, etc.). In one exemplary case, if the configuring entity inputs a set of characteristics indicating an age group between 30 and 40 years old located in region A, the computer may determine the group of users that exhibit these characteristics. In some embodiments, the group of users may be identified based on their user identifiers (e.g., name, account identifier, etc.). In other embodiments, the computer may determine the group of users without input by the configuring entity (e.g., based on a default type of group of users).

At step 1303, for each of the design components in the set of design components, the computer may determine that the group of users is able to receive the design component. For example, the computer may determine that each of the design components in the set of design components is valid (e.g., not expired) and thus can be provided to the group of users. Additionally, the computer may determine that each of the design components in the set of design components is meant to be provided to the group of users based on certain criteria. In some cases, this determination can be made based on qualification criteria input into the user interface by the configuring entity during selection of the set of design components (e.g., See 806 of FIG. 8). The computer may indicate whether the group of users qualifies to receive certain design components by sending notifications to the configuring entity, such as by updating the user interface with messages (e.g., alerts).

It is understood that qualification criteria may be selected based on any attributes that may be associated with users, such as age, region, affiliations (e.g., universities, businesses, etc.), historical behavior (e.g., traveling behavior, spending behavior, etc.), predictive behavior (e.g., predicted traveling behavior, predicted spending behavior, etc.). In an exemplary case, the qualification criteria may indicate that a certain design component (e.g., leather seats, new navigation system, etc.) should only be provided to users associated with a certain status (e.g., gold member status). The computer may then determine the status of the each of the group of users (e.g., by querying the segmentation engine), and if the status is fulfilled, determine that the group of users qualifies to receive the design component. In another exemplary case, the qualification criteria may indicate that a certain design component (e.g., offers or benefits) should only be provided to those that have a spending behavior over a threshold amount. The computer may then determine whether the spending behavior of each of the group of users is over the threshold amount (e.g., by querying the segmentation engine), and if so, determine that the group of users qualifies to receive the design component.

At steps 1304 and 1305, the computer may determine data associated with distributing the product including the set of design components to the group of users and may output the determined data to the user interface. Steps 1304 and 1305 are optional and do not have to be performed. In some cases, steps 1304 and 1305 can be repeated any suitable number of times. In some embodiments, the configuring entity may utilize the configurator portal to perform various analyses. For example, the configuring entity may interact with the user interface to analyze the selected set of design components or segment of users. Based on input by the configuring entity, the computer may determine data, which can include estimated return on investment values, cost values, and other values, that can indicate the potential result of distributing the product including the set of design components to the group of users. The computer may output the determined values to the user interface for review by the configuring entity (e.g., See 1014, 1020 of FIG. 10). In some embodiments, the configuring entity may modify the parameters to be utilized for an analysis, such as the selected set of design components or segment of users, upon which the computer may determine (e.g., re-compute) these values based on the modified parameters.

At step 1306, the computer may initiate production of a product including the set of design components, wherein the product is distributed to the group of users. In some embodiments, the computer may initiate production by executing an order received from the computing device operated by the configuring entity. The order may be sent from the computing device to the computer based on input (e.g., activation of “Confirm Order” button) by the configuring entity into the user interface (e.g., See FIG. 12). The order may include order details configured by the configuring entity. For example, the order may indicate the set of design components to be included in the product, information associated with the design components (e.g., information indicating how to produce or deliver design components), as well as other order details (e.g., cost, number of products to be produced, timeline for producing or delivering the products, etc.).

In some implementations, the computer may execute the order by sending instructions. For example, the computer may send instructions to a production system to produce the product according to the received order. In some embodiments, in addition to communicating with the production system, the computer may also communicate with other entities to fulfill distribution of certain design components. For example, the computer may send instructions to entities to provide offers to users through an appropriate channel (e.g., email) indicated in the selected set of design components. The product including the set of design components may be distributed to the group of users at a later time.

While the exemplary flow 1300 describes a case in which one product is configured and produced, it is understood that the flow 1300 can be applied to multiple products. For example, step 1306 may comprise initiation of production of any suitable number of products, each of which may be configured to have the same set of design components configured in step 1301. In another example, steps 1301-1306 may be repeated for each product comprising a distinct set of design components. In some implementations, these steps performed for each product comprising a distinct set of design components may be conducted in parallel. For example, step 1306 performed for one product associated with a first set of design components may be in progress while steps 1301-1306 are being performed for another product associated with a second set of design components.

It is understood that additional methods and processes may be included within the above methods and may be recognized by one of ordinary skill in the art, in light of the description herein. Further, in some embodiments of the present invention, the described methods herein may be combined, mixed, and matched, as one of ordinary skill would recognize.

In accordance with at least some embodiments, the system, apparatus, methods, processes and/or operations for event processing may be wholly or partially implemented in the form of a set of instructions executed by one or more programmed computer processors such as a central processing unit (CPU) or microprocessor. Such processors may be incorporated in an apparatus, server, client or other computing device operated by, or in communication with, other components of the system. As an example, various aspects of elements that may be present in a computer device and/or system configured to implement a method and/or process in accordance with some embodiments of the present invention. The subsystems can be interconnected via a system bus. Additional subsystems such as a printer, a keyboard, a fixed disk, and a monitor, which is coupled to a display adapter, and others are shown. Peripherals and input/output (I/O) devices, which couple to an I/O controller, can be connected to the computer system by any number of means known in the art, such as a serial port. For example, the serial port or an external interface can be utilized to connect the computer device to further devices and/or systems including a wide area network such as the Internet, a mouse input device, and/or a scanner. The interconnection via the system bus allows one or more processors to communicate with each subsystem and to control the execution of instructions that may be stored in a system memory and/or the fixed disk, as well as the exchange of information between subsystems. The system memory and/or the fixed disk may embody a tangible computer-readable medium.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components, processes or functions described in this application may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

All references, including publications, patent applications, and patents, cited herein are hereby incorporated by reference to the same extent as if each reference were individually and specifically indicated to be incorporated by reference and/or were set forth in its entirety herein.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the claims below.

What is claimed is:

1. A method comprising:
receiving, by a computer, a selection indicating a set of design components input by a configuring entity into a user interface;
determining, by the computer, a group of users; and
initiating, by the computer, production of a product including the set of design components, wherein the product is distributed to the group of users.

2. The method of claim 1, wherein determining the group of users comprises:
receiving, by the computer, a set of characteristics input by the configuring entity into the user interface; and
determining, by the computer, the group of users associated with the set of characteristics.

3. The method of claim 1, further comprising:
for each of the design components in the set of design components:
determining, by the computer, that the group of users is able to receive the design component.

4. The method of claim 1, further comprising:
determining, by the computer, data associated with distributing the product including the set of design components to the group of users; and
outputting, by the computer, the determined data to the user interface.

5. The method of claim 4, wherein the selection is a first selection and the set of design components is a first set of design components, further comprising:
receiving, by the computer, a second selection indicating a second set of design components input by the configuring entity into the user interface;
determining, by the computer, data associated with distributing the product including the second set of design components to the group of users; and
updating, by the computer, the user interface to display the data associated with distributing the product including the second set of design components to the group of users.

6. The method of claim 4, wherein the steps of determining data associated with distributing the product and outputting the data comprises:
determining, by the computer, data indicating the estimated return associated with distributing the product including the set of design components to the group of users; and
outputting, by the computer, the data indicating the estimated return to the user interface.

7. The method of claim 6, wherein the steps of determining data associated with distributing the product and outputting the data comprises:
determining, by the computer, data indicating a cost associated with distributing the product including the set of design components to the group of users; and
outputting, by the computer, the data indicating the cost to the user interface.

8. The method of claim 1, wherein the selection of the set of design components includes selection of one or more of functionalities, services, form factors, rewards, offers, and benefits.

9. The method of claim 8, wherein the selection of services includes selection of fraud analysis services or data analytics services.

10. The method of claim 8, wherein the selection of functionalities includes selection of methods of use.

11. A computer comprising:
a processor; and
a computer-readable medium coupled to the processor, the computer-readable medium including code executable by the processor for performing, by the computer, a method comprising:
receiving a selection indicating a set of design components input by a configuring entity into a user interface;
determining a group of users; and
initiating, by the computer, production of a product including the set of design components, wherein the product is distributed to the group of users.

12. The computer of claim 11, wherein the step of determining the group of users in the method comprises:
receiving a set of characteristics input by the configuring entity into the user interface; and
determining the group of users associated with the set of characteristics.

13. The computer of claim 11, wherein the method further comprises:
for each of the design components in the set of design components:
determining whether the group of users qualifies to receive the design component;
upon determining that the group of users qualifies to receive the design component, including the design component in an order for the product.

14. The computer of claim 11, wherein the method further comprises:
determining data associated with distributing the product including the set of design components to the group of users; and
outputting the data to the user interface.

15. The computer of claim 14, wherein the selection is a first selection and the set of design components is a first set of design components, wherein the method further comprises:
receiving a second selection indicating a second set of design components input by the configuring entity into the user interface;
determining data associated with distributing the product including the second set of design components to the group of users;
updating the user interface to display the data associated with distributing the product including the second set of design components to the group of users.

16. The computer of claim 14, wherein the steps of determining data associated with distributing the product and outputting the data in the method comprises:
determining data indicating an estimated return associated with distributing the product including the set of design components to the group of users; and
outputting the data indicating the estimated return to the user interface.

17. The computer of claim 14, wherein the steps of determining data associated with distributing the product and outputting the data in the method comprises:
determining data indicating a cost associated with distributing the product including the set of design components to the group of users; and
outputting the data indicating the cost to the user interface.

18. The computer of claim 11, wherein the selection of the set of design components includes selection of one or more of functionalities, services, form factors, rewards, offers, and benefits.

19. The computer of claim 18, wherein the selection of services includes selection of fraud analysis services or data analytics services.

20. The computer of claim 18, wherein the selection of functionalities includes selection of methods of use.
